(19) United States
(12) Patent Application Publication
(10) Pub. No.: US 2008/0225001 A1
(43) Pub. Date: Sep. 18, 2008

(54) Method For Controlling an Interface Using a Camera Equipping a Communication Terminal

(76) Inventors: Antoine Martin, Argenteuil (FR); Gilles Rochefort, Clamart (FR); Martin Lefebure, Courbevoie (FR)

Correspondence Address: BROWDY AND NEIMARK, P.L.L.C.;624 NINTH STREET, NW, SUITE 300, WASHINGTON, DC, 20001-5303, US

(21) Appl. No.: 11/997,280

(22) PCT Filed: Jul. 26, 2006
(86) PCT No.: PCT/FR2006/001846

§ 371 Date: Jan. 29, 2008

(30) Foreign Application Priority Data
Jul. 29, 2005 (FR) 0508188
Apr. 19, 2006 (FR) 0603525

(51) Int. Cl. G06F 3/033; H04N 7/14

(52) U.S. Cl. 345/158; 348/14.01; 348/E07.077

(57) ABSTRACT

The invention concerns a method for controlling a graphic, audio and/or video interface using a camera equipping a communication terminal which consists in acquiring and/or storing a first image, acquiring and storing a new image, computing the apparent movement by matching both images, interpreting, in accordance with a predetermined control mode, the apparent movement, into user commands, storing in a memory of said terminal the user commands, modifying the display or sound of the terminal according to the user commands and optionally inputting a command validating an element or a graphic zone, or menu opening or triggering or scrolling an audio or video file, or triggering a sound superimposition above a sound track, or executing a task or application by the user on the communication terminal and optionally transmitting same to a second terminal.

The present invention relates to a method for controlling an interface by means of a camera fitting out a communications terminal. This interface may be graphic (controlling the display on a screen) or audio (controlling the sound emitted by the loudspeakers of the piece of equipment) or both simultaneously (controlling a video).

This method, notably but not exclusively, applies to calculating in real time an apparent movement by means of a camera fitting out a communications terminal, to interpreting this apparent movement as user commands, and then to modifying the interface which results therefrom.

The method according to the invention is particularly adapted to communications terminals having limited resources both in computing power and in memory capacity.

This method may replace or advantageously complete certain repetitive pressing sequences on the keys of a terminal. The terminal may be a communications terminal, a computer or an audio or video terminal (hi-fi system, video reader).

Following the evolution of needs and technology, it is interesting to show that communications terminals increasingly involve rich multimedia contents. Not only the terminals propose a larger variety of media, but also the size of the latter does not stop increasing; the images are increasingly large and the stored texts increasingly large.

Because of the small size of most communications terminals, the capacities for the display or input control devices are limited. This has the immediate consequence of considerably burdening the graphic interfaces of these terminals. For example, images or texts have to be partially displayed in order to retain comfortable legibility. Thus, displacing the image or text requires the frequent pressing of several keys. Also, controlling the scrolling of an audio or video file is reduced to using the keys of the keyboard or the remote control keys which does not allow much freedom for light, sound or video effects, such as mixing, adding percussion effects or other superposed audio or video effects.

In very many cases, the number of pressing operations on the keys becomes rapidly prohibitive and very serious for a user; let us also and non-exclusively mention the adjustment of the luminosity, the contrast, the sound volume levels, the navigation in a menu or a set of icons, the displacements of a graphic cursor, the scrolling of a text or image, the change in the scale at which an image or a text is displayed, the triggering and the displacement in a tape or audio or video file, the scrolling of a sound track at different speeds or even the control of action games.

It is known that inputting user commands by simple voluntary movements of the communications terminal may advantageously replace certain repetitive pressing sequences on the keys. Notably, this principle makes possible use of commands proportional to the displacement of the terminal, providing a form of feedback control favorable to better interaction between the user and the terminal, and therefore to a larger comfort in use and more accurate control. Moreover, the use of commands formed by voluntary movements of the communications terminal provides new perspectives. This new user input may advantageously be used in conjunction with other terminals. For example, with this method the graphic cursor of a desktop computer may be controlled, or the volume, the contrast, the intensity, the scrolling of an audio or video file may be controlled on a piece of equipment such a hi-fi system or video reader, by means of the movements of the communications terminal. Also, external events may influence the communications terminal in its interpretation of the apparent movement into commands; for this purpose and non-exhaustively, let us mention as examples, an incoming communication which inhibits the method in order to be able to take this communication, or even a network game taking into account the actions of the other players.

The movement of the communications terminal may be achieved via specific sensors taken on board the terminal. These sensors traditionally are accelerometers or gyroscopes. With the latter it is often possible to reference in an absolute way the position or the orientation of the terminal in space. However, these sensors pose integration problems in increasingly reduced terminals and induce production overcost. Moreover, their accuracy docs not always allow fine control of the interface by very low amplitude movements.

Now, communications terminals integrating a camera are more and more numerous. It is then legitimate to want to use this integrated camera for obtaining information on the movement of the terminal.

It is known that information on movement may be computed by means of a camera observing a textured and illuminated planar surface. However, the difficulty in computing this movement information becomes insurmountable when the camera fitting out a communications terminal, observes any scene without any constraint on illumination.

A first difficulty is that the camera fitting out a communications terminal does not generally observe a planar surface or even a single object, and therefore the observed movement results from the movement of the camera and of the objects present. Computing the three-dimensional movement of the camera with any image sequence as sole piece of information, is still to a large extent an open problem, where most of the difficulties remain unsolved. In the present state of knowledge, it is therefore not conceivable to a posteriori restore all the movements of the terminal only from images acquired by the camera.

A second significant difficulty is that, as the illumination of the scene cannot be controlled by the device, even by using a flash, the color intensities of the textures recorded in the images of the camera vary in an unpredictable way in the successive images. This then prohibits the use of well-known techniques for computing the apparent movement based on the constancy of the intensities of the colors of the observed textures.

The object of the present invention is to find a remedy to these drawbacks and to allow the apparent movement to be computed in real time by means of images from the camera, and then to interpret this apparent movement as user commands. This type of system may advantageously be used when the intention is to navigate in a menu, to displace an image or text, or to position a graphic cursor, or even when games are played requiring the control of a movement in several directions simultaneously and intuitively, or else to control the sound volume, the sound or light contrast, the light intensity, the scrolling of an audio or video file, or to add sound effects by superposition on the audio file or to mix effects on sound or multimedia tapes.

Thus, the method according to the invention comprises the following steps:
Acquiring a first image which is stored in memory, or storing in memory at least one image already acquired and possibly pre-processed.
Acquiring and storing in memory a new image and possibly suppressing unnecessary images from the memory.
Pre-processing the new image and possibly those stored in memory beforehand.
Computing the apparent movement by means of the pre-processed images and of a technique for matching the images.
Filtering the apparent movement in amplitude and/or in time.
Interpreting according to a pre-determined control mode, the apparent movement as user commands.
Storing user commands in a memory of said terminal and/or transmitting them to a second terminal.
Changing the display or the sound of the terminal and/or of a second terminal according to the user commands.
Possibly entering a command for validating an element or a graphic area, or opening a menu, or triggering or scrolling an audio or video file, or triggering a superposition of sound on top of a sound track, or executing a task or an application by the user on the communications terminal and possibly transmitting it to a second terminal.

The computation of the apparent movement is a problem widely dealt with in the literature, and an exhaustive synthesis of which may notably be found in the articles of the journals Brown, L. G., A survey of Image Registration Techniques, 1992, and Zitova and Flusser, Image Registration Methods: a survey, 2003.

Apart from the computation of a dense movement which is irrelevant in our case where a single piece of information on the movement is required, we note two main approaches for computing the apparent movement by means of parametric models: an indirect approach which consists of matching primitives from the images; and a direct approach which utilizes the equation for optical flow conservation, described in Horn and Schunck, Determining Optical Flow, 1981. This last very widespread approach assumes as a postulate that any variation in intensity of the images over time is exclusively due to the displacement of an object, the perceived intensity of which is supposed to be constant in the successive images, or from the observation point of the scene.

The indirect methods proceed with computing the movement in three steps: (i) extracting the primitives (corners, regions, etc.), (ii) pairing the primitives over several images, (iii) adjusting the parametric model. The delicate points of these methods deal with the selection of the primitives to be extracted, of their numbers, and also with the rejection of false pairings. With these methods, it is possible to rediscover movements of large amplitude if certain primitives may be paired between successive images. Nevertheless, each of these steps may prove to be costly both in terms of computation complexity and memory occupancy. Accordingly, these methods do not seem to be indicated within the scope of applications on board the terminals with limited memory resources and limited computing power, the cameras of which have low resolution in a preview mode.

The direct methods compute the movement from the intensities of the image. The computation of the dense movement is a sub-determined problem which requires adding an additional constraint. For example, estimation of a dense displacement field is performed by means of prior regularity as in Horn and Schunck, Determining Optical Flow, 1981, or a constraint of local uniformity as in Lucas and Kanade, An Iterative Image Registration Technique with an Application to Stereo Vision, 1981. By searching for a movement described by a global parametric model, as described in Bergen et al., Hierarchical model-based motion estimation, 1992, we introduce a sufficient constraint on the displacement field.

In order to compute the movement between two images, parameters of the movement model which minimize a given criterion are sought. This criterion is most often a criterion of the least square type, and is globally computed on the whole of the pixels of the image. It is also possible to generalize this criterion by a robust standard similar to the one described in Odobez and Bouthemy, Robust Multiresolution Estimation of Parametric Motion Models, 1995. However the minimization of such a criterion becomes iterative and cumbersome in terms of computing cost.

It is known that direct computing techniques do not allow estimation of movements of large amplitudes and this in spite of the use of multi-scale techniques as in Burl and Adelson, The laplacian pyramid as a compact image code, 1983.

In order to find a remedy to these drawbacks and to thereby reduce the computing time and compute apparent movements of large amplitude, the method according to the invention proposes preprocessing of the images by reducing them by a predetermined factor f.

As explained above, because of frequent and unpredictable changes in the illumination conditions of the scene and in the automatic control of the balance of whites of the camera, the color intensities of the recorded textures in the images vary in the successive images. Now, the direct methods based on intensity differences of the images are very sensitive thereto and may then provide approximate or even absurd results.

In order to find a remedy to this drawback, the method according to the invention comprises preprocessing of the images by histogram equalization so as to restore a series of images, the intensity levels of which are then standardized.

Further, the images acquired in an economical mode by the camera are generally of low resolution and noisy.

In order to suppress this drawback, the invention proposes their preprocessing by reducing the number of representation levels of the color intensities.

It is known that multi-scale techniques pose the delicate problem of propagation of the motion information from one scale to the other. However, these methods compute a specific movement when they are well initialized.

The object of the method according to the invention is notably to find a remedy to this drawback by performing the computation of the apparent movement with two successive images possibly preprocessed as follows:
Both images are reduced by a factor f
The rough movement is computed by means of the previously reduced images and is multiplied by the factor f
A resized image is computed by means of a first non-reduced image and by the rough movement
The residual movement is computed by means of the resized image and of the second non-reduced image
The apparent movement is computed by adding the rough movement and the residual movement.

The method according to the invention proposes that the computation of an apparent translational movement m is performed by means of two images I₁ and I₂, and comprises the following steps:
Computing a vector, the components of which are sums of the products of space derivatives of a first image by the intensity differences of both images;
computing a matrix, the coefficients of which are sums of products of space derivatives of a first image with each other;
computing the determinant and cofactors of the previously computed matrix;
computing the components of the movement by means of the previously computed vector, determinant and cofactors.

Owing to the degradation of the images transmitted by the camera in the economical acquisition mode, the computation may provide an apparent movement which is corrupted by noise, or which may have absurd values.

Advantageously, filtering the apparent movement may then consist of canceling each of its components if the latter, as an absolute value, is lower than a predetermined threshold and, in the other cases, of reducing or increasing it by this same threshold. A non-limiting example of such filtering in the case of translation is given by the following formula:

m′=(m₁′,m₂′)=(sign(m₁).max(O,|m₁|−s),sign(m₂).max(O,|m₂|−s)).

Advantageously, in order to filter the absurd results out of the movement computation, filtering may consist of imposing an upper limit and lower limit for each of its components.

Advantageously, the displacement of the graphic elements or the adjustment of the sound or light or contrast level or the scrolling of the audio or video file will be performed in proportion to the computed apparent movement, with a gain possibly proportional to this apparent movement.

The present invention also proposes that the apparent movement be interpreted as commands of the graphic and/or audio and/or video interface according to the application context and/or the simultaneous pressing of one or several keys of the keyboard by the user.

The different modes for controlling the graphic interface according to the invention concern:
displacement
change in scale
rotation
scrolling
navigation in a menu
selection and/or validation
luminosity or contrast level

The different modes for controlling the audio interlace according to the invention concern:
sound volume
sound contrast

The graphic and/or audio and/or video elements which may be controlled in this way may consist in:
an image
a text or a document
a cursor
a selection area
an icon
a menu
a list
a sound track
a video

For example, an apparent movement in a certain direction may be interpreted as a command for changing scale by forward zooming, and as a command for changing scale in the opposite direction by backward zooming. Also, an apparent movement in a certain direction may be interpreted as a command for displacing a graphic and/or audio and/or video element in the same direction or in the opposite direction. An apparent movement in a certain direction may be interpreted as a command for rotating a graphic element in a certain direction and in the opposite direction when the filtered apparent movement is in an opposite direction. An apparent movement in a certain direction may be interpreted as a command for increasing the sound or light or contrast level and for reducing the sound or light or contrast level when the filtered apparent movement is in an opposite direction.

The method according to the invention may also be used for controlling graphic and/or audio and/or video elements of another terminal connected via a wire or aerial route (via infrared, Bluetooth, Wifi, GSM, GPRS, UMTS, CDMA or W-CDMA or Internet) to the communications terminal conducting the measurement of the apparent movement. An application of this method may therefore consist of controlling the graphic cursor of a PC or another terminal from a communications terminal fitted out with an integrated camera.

Advantageously, the apparent movement may be computed and interpreted as a user command only when a key associated beforehand with a control of the interface is kept pressed down, and may no longer be computed or interpreted as a user command when none of these keys is pressed down.

The method according to the invention also allows other user inputs to be taken into account in combination with the apparent movements like voice commands, commands received from an external keyboard or from another

terminal physically connected or connected via infrared, Bluetooth, Wifi, GSM, GPRS, UMTS, CDMA or W-CDMA or Internet.

It is also possible with this invention to adjust the sound and light levels and contrasts, to trigger a sound, a series of sounds, the scrolling of an audio or video file, fast scrolling in one direction or in the other of an audio or video file, to produce superposition effects of sounds or images or mixing effects of sound by means of the voluntary or involuntary movement of the user of the piece of equipment.

Embodiments of the invention will be described hereafter, as non-limiting examples with reference to the appended drawings, wherein:

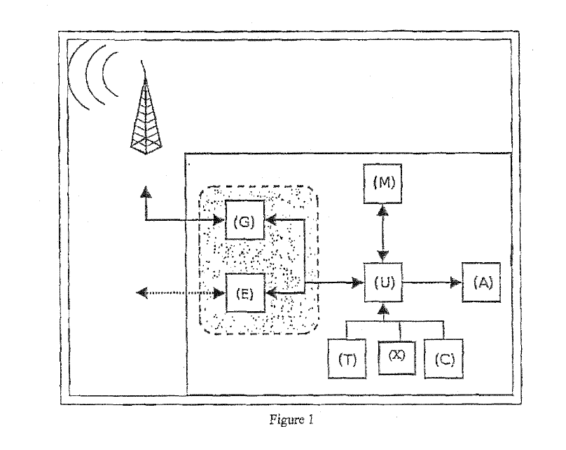

FIG. 1 is a schematic illustration of a system for controlling the graphic and/or audio and/or video interface of a communications terminal by means of a camera fitting out this same terminal;

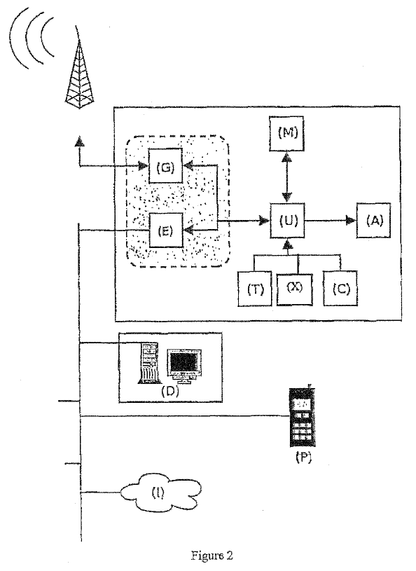

FIG. 2 is a schematic illustration of a system for controlling the graphic and/or audio and/or video interface of a portable or desktop computer, of another communications terminal or further any device connected through a local network or even Internet, by means of camera fitting out a communications terminal.

In the examples shown in FIG. 1, the system for applying the method according to the invention involves a device integrating at the very least a graphic display (A), a central processing unit (U), a memory (M), a camera (C), a keyboard (T), a loudspeaker (X), communication means (G) and possibly wire or aerial interfaces (E) with other devices.

In the example shown in FIG. 2, the system for applying the method according to the invention involves, in addition to the elements already described in FIG. 1, several other devices such as a portable or desktop computer (D), another communications terminal (P), or further any device connected through a local network or even Internet (I), the graphic and/or audio and/or video interface of which may thereby be remote-controlled.

1. A method for controlling a graphic interface by means of a camera fitting out a communications terminal, comprising the following steps:
acquiring a first image which is stored in memory, or storing in memory at least one image already acquired and possibly pre-processed,
acquiring and storing in memory a new image and possibly suppressing unnecessary images from the memory,
pre-processing the new image and possibly those previously stored in memory, this pre-processing comprising standardization of the intensity levels of the image according to a process comprising a histogram equalization leading to a series of images, the levels of which are standardized, on the one hand, and a reduction of the number of presentation levels of the intensities of the colors on the other hand,
computing the apparent movement by means of the pre-processed images and a technique for matching images,
filtering the apparent movement in amplitude and/or in time,
converting according to a predetermined control mode, the apparent movement into a user command signal,
storing user commands in a memory of said terminal and/or transmitting them to a second terminal,
changing the display of the terminal and/or of a second terminal according to the user commands,
possibly entering a command for validating an element or a graphic area or an opening of a menu, or executing a task or an application, by the user on the communications terminal and its possible transmission to a second terminal.

2. The method according to claim 1, wherein the pre-processing operations comprise a reduction of the image and/or a reduction in the number of colors.

3. The method according to claim 1,
wherein the matching technique used for computing the apparent movement estimates a global parametric model.

4. The method according to claim 1,
wherein the matching technique used comprises a step of minimizing a quadratic criterion formed on the intensity difference between the images.

5. The method according to claim 1,
which comprises computation of the apparent movement by means of two successive possibly pre-processed images said computation comprising the following steps:
reducing both images by a predetermined factor f
computing the rough movement by means of the previously reduced images and multiplying it by the factor f
computing a resized image by means of a first non-reduced image and of the rough movement
computing the residual movement by means of the resized image and of the non-reduced second image
computing the apparent movement by adding the rough movement and the residual movement.

6. The method according to claim 1, wherein the apparent translational movement m between both images I₁ and I₂, is computed by means of the following formula:
$$\begin{matrix}m = {M}^{- 1} \cdot b \\ = \frac{1}{det ( M )} cof ( M ) \cdot b , \\ M = {\sum }_{( i , j )} ∇ {{I}_{1} ( i , j )}^{t} \cdot ∇ {I}_{1} ( i , j ) , \\ b = {\sum }_{( i , j )} ∇ {I}_{1} ( i , j ) ( {I}_{2} ( i , j ) - {I}_{1} ( i , j ) ) .\end{matrix}$$

7. The method according to claim 1, wherein the technique for matching the images comprises the following steps:
extracting the points of interest
pairing the points of interest between the images
computing the apparent movement which is consistent with the found pairings.

8. The method according to claim 1, wherein filtering the apparent movement consists of canceling each of its components, if the latter in absolute value is less than a predetermined threshold and, in the other case, of reducing or increasing it by this same threshold.

9. The method according to claim 1, wherein the filtering of the apparent movement limits the values of each of its components between a lower limit and an upper limit.

10. The method according to claim 1, wherein the displacement of graphic elements is proportional to the computed apparent movement, with a gain possibly proportional to the apparent movement.

11. The method according to claim 1, wherein the control mode of the graphic interface by means of the apparent movement relates to displacement or to change in scale or to rotation or to scrolling or to navigation in a menu or to selecting and/or validating graphic elements.

12. The method according to claim 1, wherein the change in the display of the communications terminal or of a second terminal relates to an image or text or document or cursor or selection area or icon or menu or list.

13. The method according to claim 1, wherein the graphic interface has a control mode which is selected by the user by pressing down a key of the keyboard which is associated with it beforehand.

14. The method according to claim 13, wherein the apparent movement is computed if a key associated with the control mode of the interface beforehand is kept pressed down, and is no longer computed or interpreted as a user command if none of these keys is pressed.

15. The method according to claim 1, wherein the graphic interface has a control mode which is selected by the user by means of a voice command, a command received from an external keyboard or from another terminal physically connected or connected via infrared, Bluetooth, Wifi, GSM, GPRS, UMTS, CDMA or W-CDMA or Internet.

16. The method according to claim 1, wherein an apparent movement in a certain direction is interpreted as a command for changing scale by forward zooming, and as a command for changing scale by backward zooming in the opposite direction.

17. The method according to claim 1, wherein an apparent movement in a certain direction is interpreted as a command for displacement of a graphic element in the same direction or in the opposite direction.

18. The method according to claim 1, wherein an apparent movement in a certain direction is interpreted as a command for rotating a graphic element in a certain direction and in the opposite direction if the filtered apparent movement is in the opposite direction.
